(19) United States
(12) Patent Application Publication
(10) Pub. No.: US 2018/0121908 A1
(43) Pub. Date: May 3, 2018

(54) CROSS DEVICE DIGITAL WALLET PAYMENT SYSTEM AND PROCESS

(71) Applicant: MasterCard Asia/Pacific Pte Ltd, Singapore (SG)

(72) Inventors: Eric Jian Hui Lin, Singapore (SG); Rajen Prabhu, Singapore (SG); Krishnadas Mohandas, Singapore (SG)

(21) Appl. No.: 15/783,583

(22) Filed: Oct. 13, 2017

(30) Foreign Application Priority Data
Nov. 1, 2016 (SG) 10201609116S

(51) Int. Cl. G06Q 20/36; G06Q 20/40

(52) U.S. Cl. CPC G06Q 20/3674; G06Q 20/40145; G06Q 20/4012

(57) ABSTRACT

There are provided systems and processes for performing a cross device digital wallet payment. The systems and processes can facilitate express checkout and other ease of payments.

### CROSS-REFERENCE TO RELATED APPLICATION

This application is a U.S. National Stage filing under 35 U.S.C. § 119, based on and claiming benefit of and priority to SG Patent Application No. 10201609116S filed Nov. 1, 2016.

### TECHNICAL FIELD

The present invention relates to a system and process for completing a digital wallet payment from a primary device for a transaction initiated on a secondary device.

### BACKGROUND

The use of electronic payment services has increased dramatically in recent decades. In particular, credit and debit card-based payment services have become integrated into everyday life due to their ability to allow a customer to complete purchases via the electronic transfer of funds from a payment account to a merchant's account. Card-based payments offer many advantages over cash payments, including that the customer can transfer funds to a merchant in any currency without needing to transport physical denominations or having to manually perform conversions from one currency type to another, while retaining the efficiency of a cash exchange. More recently, mobile payment services (e.g. Paypal, ApplePay, Android Pay, etc.) have been developed to allow customers to make payments without a physical credit or debit card, through the use of a portable mobile device, such as a smartphone. One of the most common types of these services is a digital wallet application which operates on the mobile device of a customer by storing the details of one or more of the customer's payment accounts. Digital wallet applications allow the customer to make electronic payments from a selected payment account to a merchant without the use of a physical payment object, such as a credit card, that is associated with the payment account.

Despite the convenience of these payment technologies, there remains room for improvement. It is desired to provide a system and process for digital wallet payments that alleviates one or more difficulties of the prior art, or to at least provide a useful alternative.

### SUMMARY

In a first aspect, there is provided a process for performing a cross device digital wallet payment, including: receiving payment request data from a secondary device, the payment request data representing a request for payment information to complete a transaction on a merchant application of the secondary device; processing the received payment request data to determine: (i) primary device data, and digital wallet application data representing characteristics of a digital wallet application of the primary device; and (ii) payment notification data representing a notification of the request for payment information; transmitting the payment notification data to the primary device; receiving, from the primary device, payment information data to complete the transaction, said payment information data including an indication of a payment source associated with the digital wallet application; and transmitting the payment information data to the secondary device.

There is also provided a cross device digital wallet payment system, including at least one computing device being configured to perform a cross device digital wallet payment by carrying out the steps of: receiving payment request data from a secondary device, the payment request data representing a request for payment information to complete a transaction from a merchant application of the secondary device; processing the received payment request data to determine: (i) primary device data, and digital wallet application data representing a digital wallet application of the primary device; and (ii) payment notification data representing a notification of the request for payment information; transmitting the payment notification data to the primary device; receiving, from the primary device, payment information data to complete the transaction, said payment information data including an indication of a payment source associated with the digital wallet application; and transmitting the payment information data to the secondary device.

In another aspect, there is provided a process for performing a cross device digital wallet payment, including: receiving payment notification data representing a notification of a request for payment information to complete a transaction, said transaction initiated by a merchant application of a secondary device;
processing the payment notification data to generate payment source data representing a payment source to be used to complete the transaction, said payment source determined by a digital wallet application; and processing the payment instrument data to generate payment information data representing the requested payment information.

In a final aspect, there is provided a cross device digital wallet payment system, including at least one computing device being configured to perform a cross device digital wallet payment by carrying out the steps of: receiving payment notification data representing a notification of a request for payment information to complete a transaction, said transaction initiated by a merchant application of a secondary device; processing the payment notification data to generate payment source data representing a payment source to be used to complete the transaction, said payment source determined by a digital wallet application; and processing the payment instrument data to generate payment information data representing the requested payment information.

### BRIEF DESCRIPTION OF THE DRAWINGS

Some embodiments of the present invention are hereinafter described, by way of example only, with reference to the accompanying drawings, wherein:

FIG. 1 is a block diagram of a cross device digital wallet payment system in accordance with some embodiments of the present invention;

FIG. 2 is a block diagram of a computing device within the cross device digital wallet payment system;

FIG. 3 is a flow diagram of performing a cross device digital wallet payment in accordance with some embodiments of the present invention;

FIG. 4 is a flow diagram of a digital wallet application setup process of the cross device digital wallet payment process;

FIG. 5 is a flow diagram of a transaction initiation process of the cross device digital wallet payment process;

FIG. 6 is a flow diagram of processing a digital wallet payment request of the cross device digital wallet payment process;

FIG. 7 is a flow diagram of a process for performing a digital wallet payment during the processing of a digital wallet payment request; and

FIG. 8 is a flow diagram of a transaction generation process of the cross device digital wallet payment process.

### DETAILED DESCRIPTION

Overview

The inventors have identified some specific shortcomings with existing digital wallet based payment technologies. Recently, there has been a significant increase in the use of mobile computing devices, where it is not uncommon for an individual to have access to more than one smartphone, laptop and/or tablet device. As online shopping becomes more popular, customers desire to purchase goods and/or services using different mobile computing devices, where the choice of a particular device is based on their circumstances at the time of the purchase. Digital wallet mobile applications (such as Apple Pay, Samsung Pay and HCE wallets) allow a customer to conduct online transactions conveniently and safely using a payment account associated with a payment source (such as a credit card), the details of which are securely stored by the digital wallet.

However, existing digital wallet solutions are designed to authenticate payments for transactions made from the device on which the wallet application is executed. That is, when using these conventional digital wallet technologies the customer may be limited to initiating the purchase of desired goods and/or services from the same computing device as that from which the digital wallet is operated.

Accordingly, there are several significant drawbacks to conventional digital wallet payment solutions. First, customers will typically not have the same digital wallet application installed on each of the mobile computing devices that they may wish to use to purchase goods and/or services. Digital wallet applications are often specific to a particular type of device, or operating system. As a result, a customer often cannot install the same digital wallet application on all computing devices from which it is desired to make payments. Consequently, the customer may be forced to use different digital wallet software applications on each of their devices due to the incompatibilities between particular applications and devices.

Second, customers may need to make purchases from devices on which a digital wallet application is not installed, and where it is not desirable (or possible) to install such an application. For example, a customer who is borrowing a tablet device from a friend, or who is using a laptop owned by their employer, may not have the option to install digital wallet application software on the tablet or laptop device in order to enable digital wallet payments for purchases initiated using that device. In this case, the customer would be limited to using a web-based payment service (e.g. PayPal) or would need to enter their payment source (e.g. credit card) details into the device directly, which is less convenient and safe than the use of a digital wallet application.

Finally, even if a digital wallet application that is uniformly compatible across arbitrary mobile devices and operating systems is available, the customer would still need to install, and possibly configure (e.g. by entering details of one or more payment source), the digital wallet application for each mobile device that they may need to use to initiate a payment. This is problematic in situations where the customer does not want to enter the details of their one or more payment sources and/or their personal identification information into the particular device that is used to initiate an online transaction. For example, the customer may wish to make a purchase from a public device (such as from a PC machine at an internet café) without using a digital wallet application running on the machine in order to preserve the security of their payment account details.

The described embodiments of the present invention include a cross device digital wallet payment system and process for completing an online payment transaction for a transaction that is initiated from a secondary mobile computing device (referred to herein as a “secondary device”) using a digital wallet that resides on a customer's primary mobile computing device (referred to herein as a “primary device”). Specifically, in the described system and process, a customer's primary device, such as a smartphone or tablet, has installed a digital wallet application that is configured to store the details of one or more payment sources corresponding to payment accounts of the customer (referred to herein as the “user”). The digital wallet application allows the user to make arbitrary payments using a selected payment source upon receiving authentication information from the user (such as a PIN code or biometric identifier). The digital wallet application executing on the user's primary device is associated with a wallet profile of that user maintained by a particular wallet server device. The wallet server maps the combination of the user's digital wallet application and the primary device executing that application to the user's wallet identifier. Cross device digital wallet payment authentication can be performed when the user provides the wallet identifier to a merchant application executing on the secondary device, and from which the corresponding transaction is initiated.

Specifically, the user operates the secondary device to make a purchase from the merchant, for example by navigating a website or corresponding mobile application of the merchant and selecting particular goods and/or services offered for purchase. To complete the transaction, the user provides an indication of their digital wallet in the form of the wallet identifier, which is transmitted from the merchant application to the wallet server. The wallet server sends notification information to the digital wallet application on the primary device in respect of the payment information requested by the merchant, allowing the user to operate their digital wallet application to authorise payment for the transaction initiated on the secondary device.

The wallet server receives the authenticated payment information from the digital wallet application, and passes this information back to the merchant application. The payment is completed via the creation of a payment transaction message by a payment gateway of the merchant. The payment transaction message is generated based on payment information which specifies a payment source that was selected by the user via the digital wallet application executing on the user's primary device. The payment transaction is processed in accordance with standard procedures for financial transaction processing that occur between the merchant acquiring institution (the “acquirer”), the card association entity of the selected payment source (such as MasterCard), and the issuing financial institution (the “issuer”) associated with the payment account of the selected payment source.

In the described embodiments of the system and process, the merchant application is configured to allow for cross device digital wallet payments by the use of a digital wallet plug-in, or other dynamic content element, which is integrated with the conventional purchasing functionality provided by the merchant. A digital wallet based payment is initiated when the user selects a corresponding digital wallet payment option of the merchant application, and subsequently enters their wallet identifier. The digital wallet plug-in is configured to interface with the wallet server via an application programming interface (API) which specifies: the credentials required from the user to perform the digital wallet payment; and the payment data received by the merchant application in response to a successful authentication of the payment. Specifically, the digital wallet plug-in and API mirror the functionality that is provided by a locally executing digital wallet application, such that the other payment elements of the merchant application remain unchanged from their conventional configuration (i.e. where the digital wallet payment is performed when the merchant and digital wallet applications are executed from the same device). However, while the conventional configuration remains substantially unchanged, an additional data message/data element might be included to indicate that the transaction was authenticated from a separate device. This is to enable the merchants/card association entity/issuer/acquirer to better track and understand cross-device/cross-platform usage behaviour.

The wallet identifier provided by the user to perform a cross device digital wallet payment can be configured to include any combination of information that is stored by the wallet server of as part of the wallet profile for each user. The wallet identifier uniquely specifies any wallet profile registered with the cross device digital wallet payment system. The wallet profile of a user typically includes user identification information such as the user's name, address, and their contact details such as an email address or contact telephone number. In the described embodiments, the primary device is a smartphone device, and the wallet identifier is the mobile phone number of the primary device. However, the skilled addressee will appreciate that other embodiments may use other information as an alternative to, or in combination with, the mobile phone number. For example, a mobile phone number and PIN code combination may be used as the wallet identifier in order to provide additional security against the unauthorised use of the primary device to conduct a digital wallet payment.

In the described embodiments of the system and process, communication between the primary device and the wallet server occurs via Internet protocols and over one or more local or wide area communication networks. However, in other embodiments the primary device is configurable to utilise any communication method and/or protocol available to the device in its typical operation for the purpose of communicating with the wallet server. That is, the network configuration and data packet level transfer mode can be configured based on the type of primary device executing the digital wallet application. For example, a smartphone device may engage in communication with the wallet server to transmit and receive payment requests and associated payment information via a wireless network such as the 3G or 4G mobile networks, or over Wi-Fi. However, if the primary device is a laptop, then a wired network connection (such as an Ethernet based connection) may be used.

The cross device digital wallet payment system and process described herein advantageously provides a digital wallet payment solution that:
1) allows a customer to authenticate payments to a merchant for purchases that are initiated from a secondary device using a digital wallet located on a primary device, and as such avoids the need for the installation, operation, and maintenance of different digital wallet applications on a plurality of the customer's mobile computing devices that may possibly be used to initiate such transactions;
2) improves the ability of the customer to make online transactions and to utilise digital wallet technology, since a transaction can be initiated from a device that does not support digital wallet applications while completing the corresponding payment from the customer's own digital wallet enabled device; and
3) enables a customer to make payments with increased security, since the customer's payment source details are confined to the digital wallet application executing on a single primary device, therefore reducing the likelihood that the customer's corresponding payment accounts will be compromised.

System

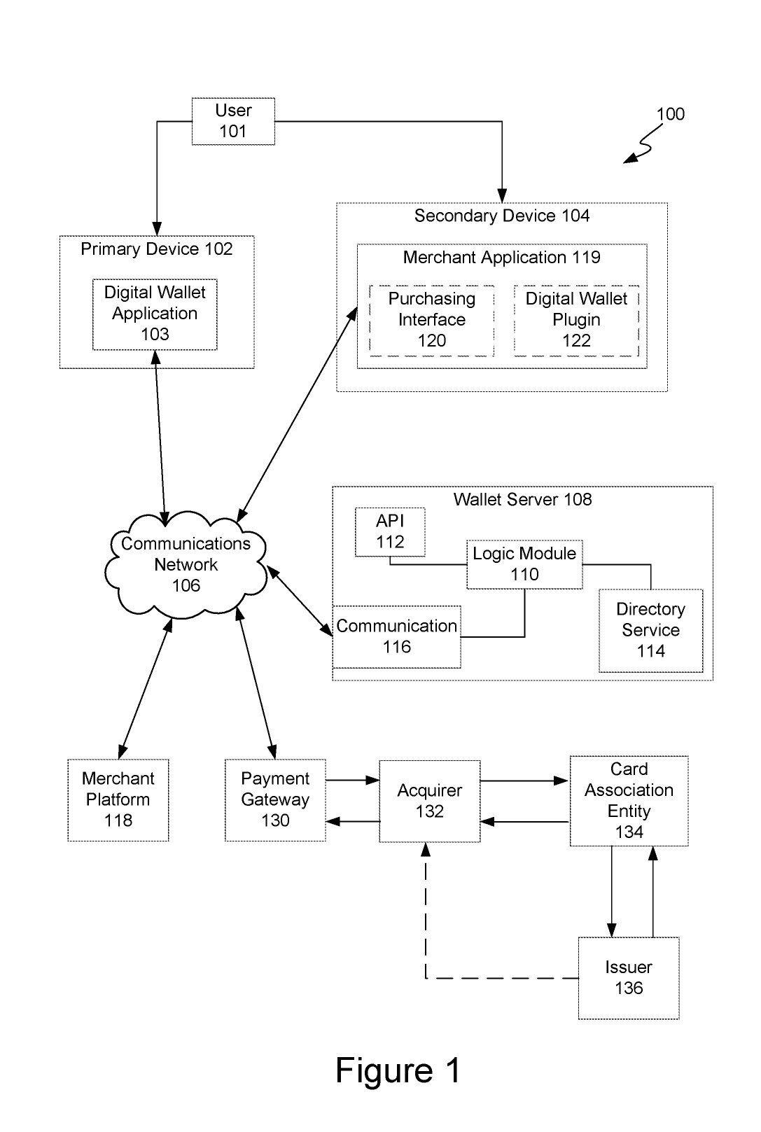

As shown in FIG. 1, the cross device digital wallet payment system 100 includes primary 102 and secondary 104 devices operated by a user 101, the devices connected to a communications network 106. The user 101 operates the secondary device 104 to initiate a transaction from a merchant using a merchant application 119, where payment for the transaction is made from a digital wallet application 103 executing on primary device 102. The merchant application 119 is executed on the secondary device 104 which is connected to the merchant platform 118 over the communications network 106. The merchant application 119 includes a purchasing interface 120 and a digital plug-in 122 that are configured to integrate cross device digital wallet payments into the merchant's existing purchasing infrastructure. Cross device digital payments are supported by a wallet server 108 which communicates with the secondary device 104, and also with the primary device 102 by the communications network 106. Communication network 106 can be a local area network, or a wide area network such as the Internet, for the purpose of facilitating exchange of data between the primary device 102, the secondary device 104, the wallet server 108, and a merchant platform 118. In the described embodiments, a secure transport layer communications protocol, such as https, is used for the communication of data between the respective devices. In other embodiments, separate communications networks may be used for communication between the primary device 102 and/or the secondary device 104 and the wallet server 106, and the secondary device 104 and the merchant platform 118.

In the described embodiments, the merchant application 119 is implemented as a software application residing on a merchant platform 118 device that is configured to host the merchant application 119 and associated data for the secondary device 104. The secondary device 104 obtains a copy of the merchant application 119 from the merchant platform 118 which is executed locally on the secondary device 104. Non-limiting examples of the merchant application 119 include a mobile device application of the merchant, and a generic web browser application configured to render a website of the merchant, for the purpose of allowing the user 101 to purchase goods and/or services offered for sale by the merchant. The purchasing interface 120 and digital plug-in 122 elements are configured according to the type and the nature of the merchant application 119. For example, in the case of a merchant website, the purchasing interface 120 can be a particular page element that presents the user 101 with a selection of items to purchase and corresponding options to purchase (or “checkout” with) these items. The digital wallet plug-in 122 can be a dynamic element, such as an element implemented in XML, JavaScript, or another web-based language, that is activated when the user 101 elects to purchase goods and/or services via a cross device digital wallet payment. The merchant application 119 is in communication with a payment gateway 130 configured to enable the secure transmission of payment data from the merchant application 119 to the acquirer 132, for the purpose of conducting a transaction to purchase the selected items. A card association entity 134 communicates with the acquirer 132 to process payment transactions made in respect of a credit/debit card associated with a particular card association entity 134, and issued by an issuing financial institution (the issuer 136) for which the user 101 has an associated account. The processing of the payment transactions by the card association entity 134, the acquirer 132, and the issuer 136 is in accordance with standard financial payment system processes.

The wallet server 108 is a computer server device configured to receive a cross device digital wallet payment request from the merchant application 119 in association with a transaction initiated by the user 101 via the secondary device 104. The wallet server 108 executes a cross device digital wallet payment application which consists of modules including a logic module 110, an application program interface (API) module 112, a directory service 114, and a communications module 116. The modules of the cross device digital wallet payment application collectively function to accept digital wallet payment requests from the merchant application 119, including an indication of the digital wallet to be used for the payment, and to notify the corresponding primary device 102 of that request (as described below).

In the described in embodiments, the notification of the digital wallet payment request is transmitted from the wallet server 108 to the primary device 102 via the communications network 106. The notification is specific to the digital wallet application 103 executing on the primary device 102, and contains elements facilitating the selection of one or more of the payment sources associated with the digital wallet application 103 for the purposes of making the payment. The digital wallet application 103 executing on the primary device 102 can be a standard digital wallet application (or personalised electronic payment service) configured to interact with the wallet server 108 for the purpose of completing cross device payments, according to the processes described herein. The combination of the digital wallet application 103 and the primary device 102 which executes this digital application 103 is referred to herein as the “digital wallet” of user 101.

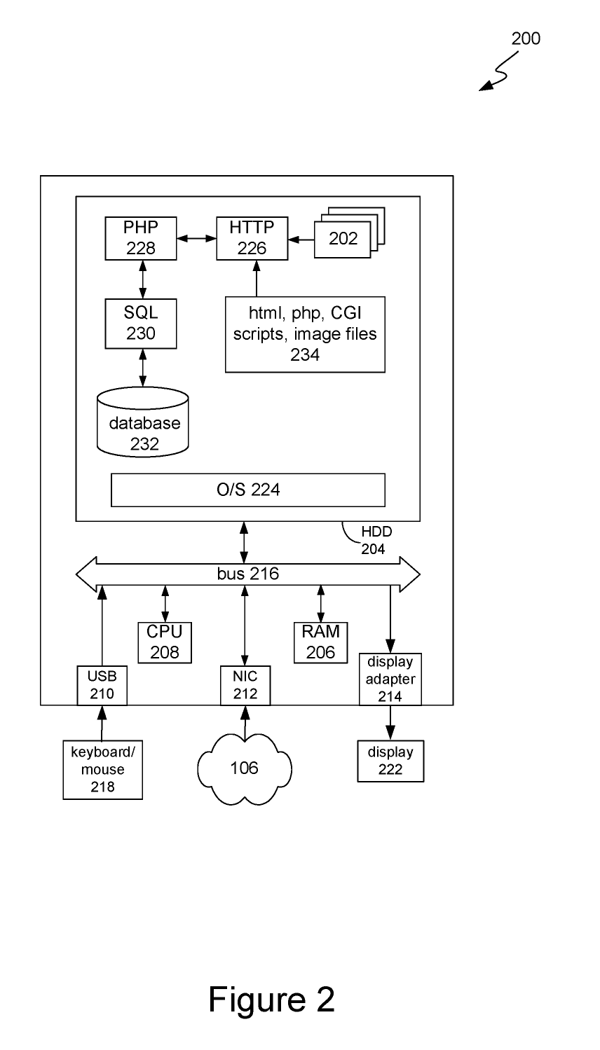

In the described embodiments of the cross device digital wallet payment system, the primary device 102, secondary device 104, merchant platform 118, wallet server 108, payment gateway 130, acquirer 132, card association entity 134 and issuer 136 devices are standard computer systems 200, such as, for example, an Intel IA-32 based computer system, as shown in FIG. 2, and the process 300 executed by the system 200 is implemented as programming instructions of one or more software modules 202 stored on non-volatile (e.g., hard disk or solid-state drive) storage 204 associated with the computer system, as shown in FIG. 2. However, it will be apparent that at least parts of the process 300 could alternatively be implemented as one or more dedicated hardware components, such as application-specific integrated circuits (ASICs) and/or field programmable gate arrays (FPGAs), for example.

The system 200 includes standard computer components, including random access memory (RAM) 206, at least one processor 208, and external interfaces 210, 212, 214, all interconnected by a bus 216. The external interfaces include universal serial bus (USB) interfaces 210, at least one of which is connected to a keyboard 218 and a pointing device such as a mouse 219, a network interface connector (NIC) 212 which connects the system 200 to a communications network 106, such as the Internet, and a display adapter 214, which is connected to a display device such as an LCD or LED panel display 222.

The system 200 also includes a number of standard software modules 226 to 230, including an operating system 224 such as Linux or Microsoft Windows, web server software 226 such as Apache, available at http://www.apache.org, scripting language support 228 such as PHP, available at http://www.php.net, or Microsoft ASP, and structured query language (SQL) support 230 such as MySQL, available from http://www.mysql.com, which allows data to be stored in and retrieved from an SQL database 232.

Together, the web server 226, scripting language module 228, and SQL module 230 provide the system 200 with the general ability to allow users of the Internet 220 with standard computing devices equipped with standard web browser software to access the system 200 and in particular to provide data to and receive data from the database 232.

However, it will be understood by those skilled in the art that the specific functionality provided by the system 200 to such users is provided by scripts accessible by the web server 226, including the one or more software modules 202 implementing the process 300, and also any other supporting scripts and data 234, including markup language (e.g., HTML, XML) scripts, PHP (or ASP), and/or CGI scripts, image files, style sheets, and the like.

Process

Accordingly, the cross device digital wallet system and process described herein allow user 101 to complete a payment for a transaction initiated via a merchant application 119 accessed from secondary device 104 (e.g. a tablet/laptop) with a digital wallet that is operated from a primary device 102, such as a smartphone, through the use of a wallet server 108 device that performs the steps of:
receiving payment request data from a secondary device 104, the payment request data representing a request for payment information to complete a transaction from a merchant application 119 of the secondary device 104;
processing the received payment request data to determine:
   i) primary device data representing characteristics of a primary device 102, and digital wallet application data representing characteristics of a digital wallet application 103 of the primary device 102; and
   ii) payment notification data representing a notification of the request for payment information, said notification for the primary device 102;
transmitting the payment notification data to the primary device 102;
receiving, from the primary device 102, payment information data to complete the transaction, said payment information data including an indication of a payment source associated with the digital wallet application 103; and
transmitting the payment information data to the secondary device 104.

The primary device 102 performs a cross device digital wallet payment via a process including the steps of:
receiving payment notification data representing a notification of a request for payment information to complete a transaction, said transaction initiated by a merchant application 119 of a secondary device 104;
processing the payment notification data to generate payment source data representing a payment source to be used to complete the transaction, said payment source determined by a digital wallet application 103; and
processing the payment instrument data to generate payment information data representing the requested payment information.

Wallet Application Setup and Registration

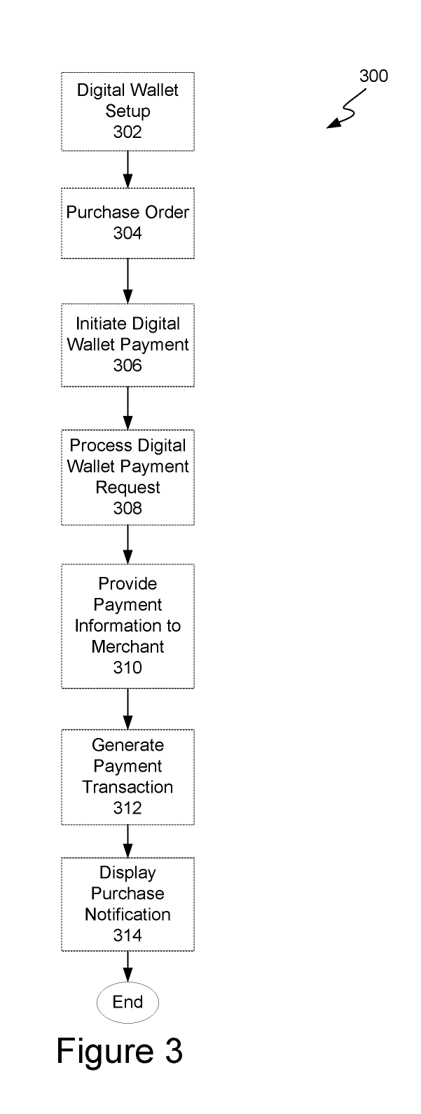

FIG. 3 illustrates a process 300 for performing a cross device digital wallet payment with the system 100. A set up operation is first performed for the digital wallet application 103 on the primary device 102 at step 302. The digital wallet application 103 allows the user 101 to store and manage one or more payment sources, such as credit/debit cards associated with a cart association entity and linked to a corresponding payment account of the user 101, for the purpose of making payments for purchases. In the described embodiments, the digital wallet application 103 is a mobile device application that executes on the operating system of the smartphone primary device 102.

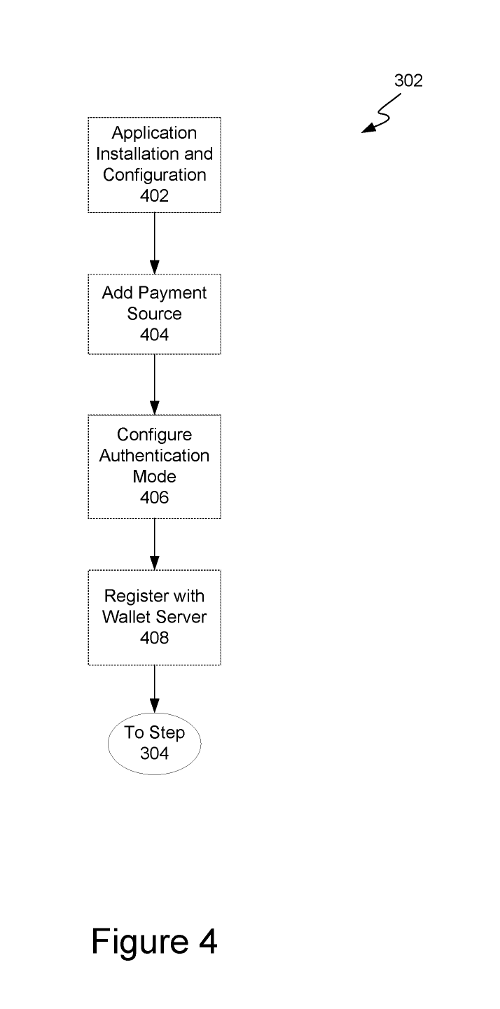

FIG. 4 illustrates the digital wallet set up process 302, which first involves the installation and configuration of the digital wallet application 103, at step 402. The digital wallet application 103 can be obtained from an online mobile application store, such as the Google Play Store or Apple App Store, depending on the operating system of the primary device 102. The digital wallet application can also be obtained by a file transfer from local media (such as a portable hard drive or flash memory), or from a connection of the primary device 102 to another computing device, the computing device having a copy of the digital wallet application files located on its storage media. Alternatively, the digital wallet application 103 can be preinstalled on the primary device 102 by the device or operating system manufacturer allowing the user 101 to bypass the initial download and/or installation steps.

Following installation, the digital wallet application 103 program instructions and data are located on one or more persistent storage devices (e.g. HDD 204) of the primary device 102. Configuration of the digital wallet application 103 involves the entry of user identification information of the user 101 into the application via graphical user interface (GUI) elements displayed on the primary device 102. The user identification information includes the first name, last name, address, and mobile telephone number of the user 101, and establishes the identity of this user for the purpose of generating payment information (as described herein below). The digital wallet application 103 can be configured to verify the user identification information entered during configuration of the digital wallet application to ensure that this information accurately corresponds to the actual identity of the user 101. For example, a verification text message may be sent to the mobile phone number provided by the user 101, with a one time password (OTP) code that the user 101 is required to enter into the digital wallet application 103 via a GUI element.

At step 404, the user 101 adds one or more payment sources to the digital wallet application 103. The user 101 selects to add a payment source using a corresponding ‘Add Payment Method’ GUI element of the digital wallet application 103. The user 101 provides an indication of the type of payment source which is to be added, such as for example a credit/debit card or an electronic payment platform account (i.e. PayPal). The digital wallet application 103 prompts the user 101 to enter the details of the particular payment source that is to be added. In the case of a credit/debit payment card, the payment source details include the payment card number, the owner name, the billing address, the expiration date, and the CVV code. The digital application 103 can be configured to perform verification of the payment source details. For example, verification of a credit card may be performed by processing an authorisation transaction for a small token amount against the card using the information provided. A rejection of the authorisation transaction by the card association entity 134, or the issuer 136 of the associated account, may provide an indication that the presented details for the card are incorrect. Upon successful verification, the payment details of the instrument are stored by the digital wallet application 103.

The digital wallet application 103 is configured to authenticate the use of an added payment source for the purpose of making a payment with that instrument. In the described embodiments, the user 101 can configure the digital wallet application 103, at step 406, to perform personal identification number (PIN) based authentication. For example, the digital wallet application can be configured to accept a 4 digit code selected by the user 101 as the payment source authentication value. The user 101 can also configure the application 103 to use biometric authentication, where a unique biometric feature, such as a fingerprint, is entered to authenticate the use of a payment source. Authentication is requested whenever the user 101 attempts to complete a payment via the digital wallet using a selected payment source (as described below).

In some embodiments, the digital wallet application 103 is configured to authenticate the use of any added payment source with a single mode (e.g. a PIN or biometric mode) and corresponding value (e.g. a particular 4-digit code or fingerprint pattern). In other embodiments, authentication can be performed for each payment source separately such that a different authentication mode and/or value can be used to authenticate a payment made using any one of the stored payment sources. For example, the user 101 can configure the digital wallet application 103 to use PIN based authentication for their ‘platinum’ high interest credit card which is rarely used, while setting a biometric identifier to authenticate their more frequently used debit card to facilitate the speed with which payments can be completed using that particular debit card. Alternatively, the user 101 may configure the authentication of each payment source to match the authentication of the corresponding physical card (e.g. by setting selecting PIN authentication mode with an authentication value matching the actual PIN of the associated credit/debit card).

The user 101 can select a payment source from those instruments that have been previously added to the digital wallet application 103 (referred to herein as the set of “candidate payment sources”) for the purpose of making a particular payment. In the described embodiments, the digital wallet application 103 allows the user 101 to modify and/or remove any of the candidate payment sources associated with their digital wallet, either during the digital wallet setup process (i.e. at step 302), or at another time thereafter. That is, the GUI elements of the digital wallet application 103 are configured to provide the user 101 with the option to do any one or more of the following: i) add a new payment source to the set of candidate payment sources of the digital wallet application; ii) remove a payment source from the set of candidate payment sources of the digital wallet application; and iii) modify the details of a candidate payment source of the digital wallet application.

At step 408, the digital wallet application 103 performs registration with the wallet server 108. Registration of the user's digital wallet involves the generation of a wallet profile on the wallet server 108 which facilitates cross device digital wallet payments by allowing the digital wallet application 103 to receive notifications of payment information requests, such that the user 101 can operate the digital wallet to complete a transaction initiated from a secondary device 104 (as described below). In the described embodiments, registration is performed when the user 101 selects to enable cross device payments from the GUI of the digital wallet application 103. In other embodiments, registration may be performed automatically in cases where the cross device payment functionality is integrated into the digital wallet application 103 (i.e. where the user 101 does not have a choice whether the cross device payment functionality is enabled or disabled).

The wallet server 108 receives a registration request from the primary device 102 via the communications module 106. The registration request includes user identification data representing the identity of the user 101; and user wallet data specifying one or more characteristics of: the primary device 102; all secondary devices 104 and the digital wallet application 103 of the user 101 executing on all the devices 102, 104. The user 101 will then be able to choose which device he would like to make payment with as all devices are configured to receive payment notifications. In the described embodiments, the user identification data represents information including an indication of at least one of the first name, last name, address, and mobile telephone number, of the user 101.

The user wallet data includes: a contact identifier of the primary device 102, such as the mobile phone number or an IP address of the device, that is interpretable by the wallet server 108 to provide cross device digital wallet payment requests to the primary device 102 (as described below); an indication of the device type of the primary device of the user (e.g. tablet, phone, laptop, etc.); and an indication of the digital wallet application 103. The indication of the digital wallet application 103 can include details of the operating system software of the primary device 102, and the specific digital wallet application 103 executing on the primary device 102, such that cross device digital wallet payment requests can be interpreted and processed by the primary device 102 to facilitate the completion of a corresponding payment via the digital wallet application 103.

The user identification and user wallet data are extracted from the registration request data by the logic module 110. The logic module 110 is configured to transmit the extracted user identification and wallet data to the directory service module 114. The directory service module 114 processes the user identification and wallet data and generates a wallet identifier that uniquely identify the combination of the digital wallet application 103 and the corresponding primary device 102 on which the digital wallet application 103 is executed among all other registered users of the system 100. In an alternative embodiment, the wallet identifier can be defined by the user. The user 110 provides the wallet identifier to initiate cross device payment. The usability will be enhanced if the wallet identifier is an ID such as a mobile number in which the user 110 is familiar with. The directory service module 114 can instead map user identification and wallet data to the wallet identifier set by the user instead. A wallet profile for the user 101 is constructed involving associating the wallet credentials of the user 101 with the combination of the user wallet data and the user identification data. The wallet profile is maintained by the directory service module 114 and allows the primary device 102 and digital wallet application 103 of the user 101 to be resolved from the wallet credentials provided by the user 101 to a merchant application 119, which subsequently forwards these credentials to the wallet server 108 (as described below).

In the described embodiments, the wallet profile of each user having a registered digital wallet with the cross device digital wallet payment system is stored in a database across ‘user’ and ‘primary device’ tables, which store the user identification and wallet information respectively. The wallet identifier is in the form of a collection of parameters of the user identification and wallet information submitted by each user during registration of a digital wallet with the system 100. Of course, the wallet identifier can also be defined by the user. The wallet identifier is determined to uniquely identify the digital wallet of the user 101 (i.e. the combination of the digital wallet application 103 and the primary device 102 which executes this application) among all other registered digital wallets. In the described embodiments, the wallet identifier consists of the mobile phone number of the smartphone primary device 102. This assumes that a particular primary device 102 and digital wallet application 103 combination is unique to a single individual (i.e. that two or more persons will not register to use the same primary device 102 and digital wallet application 103 for cross device payment functionality). In other embodiments, different wallet identifiers may be used, such as for example the user's name or email address provided during the configuration of their digital wallet application 103. Furthermore, the directory service 114 can be configured to maintain, within the wallet profile of a registered user, other information in relation to digital wallet payment requests made by that user (such as, for example, the identity of the merchant requesting the cross device digital wallet payment). The skilled addressee will recognise that the cross device digital wallet payment functionality described herein is extendable to embodiments using a wallet identifier that differs from those explicitly mentioned above.

In other embodiments, the wallet server 108 can be configured to store additional information in the directory service 114, including details of the payment sources associated with the user's digital wallet (i.e. the payment sources added within the digital wallet application 103). For example, the wallet server 108 may maintain a ‘payment source’ table which lists the card number, expiry date, and CVV code of one or more credit card payment sources added to the user's digital wallet, allowing for the digital wallet application 103 to backup or restore payment source information from the wallet server 108. Adding or removing a payment source from the digital wallet application 103 executing locally on the primary device 102 results in the digital wallet application 103 transmitting a corresponding instruction to the wallet server 108 to modify payment source records stored by the directory service 114. Furthermore, in some configurations, the user 101 can denote a particular payment source as a “default” payment source within the digital wallet application 103. The wallet server 108 can be configured to store a corresponding indication of the default payment source for this application, allowing an “express checkout” option for cross device digital wallet payments made by the user 101 (as described below).

Successful registration of the user's digital wallet with the wallet server 108 is indicated by the transmission of a registration success notification from the communication module 116 of the wallet server 108 to the primary device 102. The registration success notification includes an indication of the wallet identifier generated by the system 100 for the user's digital wallet. The registration success notification is processed by the primary device 102 and confirmation of the registration is subsequently provided to the user 101 via one or more GUI elements of the digital wallet application 103. The system of the described embodiments operates to ensure that each registered digital wallet is uniquely identifiable by the wallet identifier, as generated from the user identification and wallet data provided by the user at registration. Consequently, there may be circumstances in which a digital wallet of a particular user cannot be successfully registered.

For example, a registration request specifying a mobile phone number that is identical to a mobile phone number already recorded in the user table would be rejected by the wallet server 108 in the case that the wallet identifier generated consists only of the user's mobile phone number. If the digital wallet registration process is unsuccessful, the logic module 110 of the wallet server 108 generates a registration failure notification message. The registration failure notification message is transmitted to the digital wallet application 103 of the primary device 102 by the communication module 116. The digital wallet application 103 interprets the notification message to present a corresponding error notification message to the user 101 via the GUI elements of the digital wallet application 103. In some embodiments, the digital wallet application 103 can be configured to prompt the user 101 to modify the user identification information of their digital wallet application 103 in order to overcome the failure to register with the wallet server 108, or to provide an indication of the existing registered digital wallet which is preventing a successful registration.

Purchase Orders

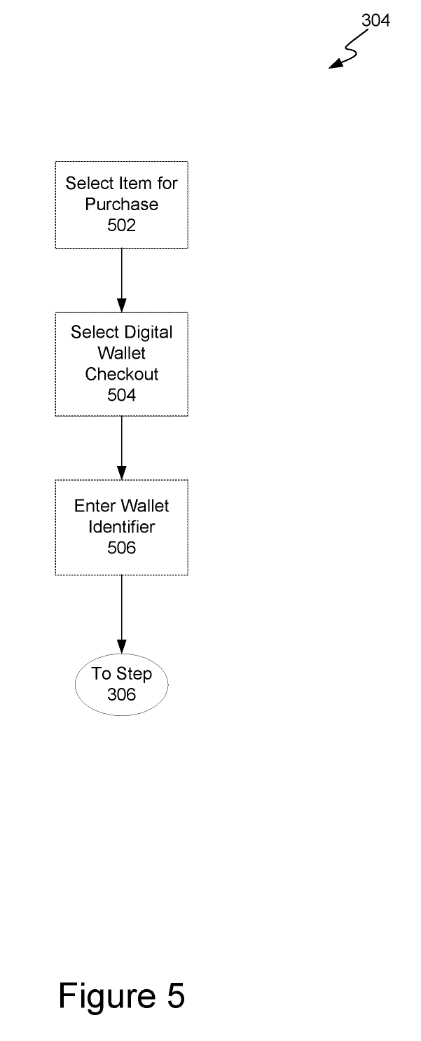

Once the digital wallet is registered with the wallet server 108, the user 101 can use the cross device digital wallet payment system 100 by first making a purchase order for merchant goods and/or services (at step 304). FIG. 5 shows the process of initiating a transaction that is to be completed via a cross device digital wallet payment made in accordance with the described system 100. The process commences when the user 101 selects to purchase an item using the merchant application 119 executing on the secondary device 104. The merchant application 119 includes a purchasing interface 120 that, when rendered by the secondary device 104, provides the user 101 with options for completing the payment of their selected goods and/or services. For example, in the case of a merchant application 119 in the form of a merchant website the purchasing interface 120 may include a specific web page displaying the selected items (such as in the user's “shopping cart”) together with graphical display elements allowing the user 101 to elect to complete their purchase using one of a variety of different payment options. The payment options can include, for example, the use of a credit card, an electronic payment service (such as PayPal), or a digital wallet.

At step 504, the user 101 selects to complete the initiated transaction via a digital wallet payment. In response, the merchant application 119 activates the digital wallet plug-in 122 which is configured to: 1) determine that a cross device digital wallet payment is required; 2) receive the wallet identifier for the cross device digital wallet payment; and 3) request payment information from the wallet server 108 using the received wallet identifier. In the described embodiments, the digital wallet plug-in 122 determines that a cross device digital wallet payment is required by requesting input from the user 101. Specifically, the digital wallet plug-in 122 presents the user 101 with an interactive GUI element allowing the user 101 to choose whether the digital wallet payment is to be performed from a local digital wallet application, or from a cross device digital wallet. This provides the user 101 with the flexibility to choose which digital wallet is to be used for the payment in situations where the user has multiple digital wallets. Specifically, this allows the user 101 to perform the payment using the digital wallet application 103 of the primary device 102 in the presence of another digital wallet application executing on the secondary device 104. The digital wallet plug-in 122 can be configured to present the aforementioned GUI element when the digital wallet plug-in 122 detects that a digital wallet application is executing or installed on the secondary device 104. In other embodiments, the digital wallet plug-in 122 can be configured to assume that the digital wallet payment is a cross device digital wallet payment.

Once the user 101 confirms that a cross device payment is desired, the digital wallet plug-in 122 captures the wallet identifier of the user 101 through GUI elements presented on the secondary device 104. In the described embodiments, for a merchant application 119 in the form of a mobile device application, the digital wallet plug-in 122 invokes a text-box, or similar element, that prompts the user 101 to enter their wallet identifier (i.e. the mobile telephone number associated with their digital wallet). Alternatively, when the merchant application 119 is a merchant website, the digital wallet plug-in 122 triggers a page redirect that presents the user 101 with a web form where their wallet identifier can be entered.

At step 506, the user 101 enters their digital wallet identifier into the text-box or web form elements triggered by the digital wallet plug-in 122. The digital wallet plug-in 122 is configured to check the validity of the wallet identifier entered by the user 101. In the described embodiments, the digital wallet plug-in 122 processes the wallet identifier using string parsing methods to ensure that the input constitutes a valid mobile phone number. For example, the plug-in 122 is configured to use a string processing algorithm that detects the presence of specific non-alphanumeric characters in the input indicating that this input cannot represent a valid telephone number.

In some embodiments, the GUI elements presented on the secondary device 104 when the digital wallet plug-in 122 is triggered allow the user 101 to select the digital wallet application 103 that is associated with their digital wallet. The type, structure and form of the wallet identifier requested from the user 101, and the processing applied to determine the validity of these credentials, can be configured to change based on the particular digital wallet application selected by the user 101. In this case, the digital wallet plug-in 122 and/or the merchant application 119 can be configured to store an indication of the form, structure and type of the wallet identifier for each supported digital wallet application. In other embodiments, the digital wallet plug-in 122 can be configured to receive information regarding the type, structure and form of the wallet identifier dynamically from the wallet server 108. For example, the digital wallet plug-in 122 may request wallet identification credential information for a plurality of digital wallet applications periodically, or on the occurrence of a specific event (such as the user 101 selecting a particular digital wallet application during the initiation of a cross device digital wallet transaction). The form, structure and type of the wallet identifier for a digital wallet application is maintained by the directory service 114 of the wallet server 108.

In the case that the wallet identifier provided by the user 101 is invalid, the merchant application 119 presents the user 101 with an error message. Otherwise, the wallet identifier is accepted by the merchant application 119 and a cross device digital wallet payment is initiated at step 306. The digital wallet plug-in 122 of the merchant application 119 transmits a payment information request to the wallet server 108 via a call to a function specified in the API 112. The payment information request contains the wallet identifier entered by the user 101 at step 506 described above. The function call invoked by the digital wallet plug-in 122 is determined based on the merchant application 119, and the form, structure and type of the wallet identifier. For example, the API 112 may specify different functions for requesting payment information depending on whether the wallet identifier includes a set of strings (e.g. a first name, and last name combination), a single string (e.g. a mobile telephone number), or an integer (e.g. a unique user ID number).

Processing the Payment Information Request

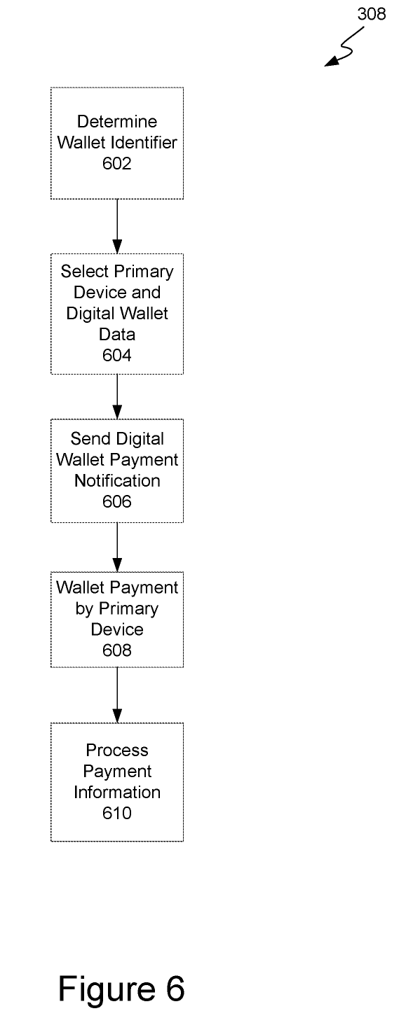

At step 308, the payment information request is processed by the wallet server 108. FIG. 6 illustrates the steps involved in the processing of the payment information request. The payment information request is received by the communications module 116 of the wallet server 108, and is subsequently transmitted to the logic module 110. In some embodiments, the payment information request involves the use of encryption techniques (such as symmetric AES encryption) to secure the wallet identifier prior to transmission. The logic module 110 can be configured to perform the corresponding decryption steps prior to processing the wallet identifier. The logic module 110 invokes the directory service 114 to process the received payment request data by selecting primary device data and digital wallet application data, which correspond to the wallet identifier of the received payment request data.

Specifically, the primary device and digital wallet application data, are determined from the set of wallet profiles maintained for the registered users of the system 100. In the described embodiments, a comparison is performed between the received wallet identifier and the corresponding fields of each entry within the user and primary device tables to determine whether the received wallet identifier match to those of a wallet profile registered with the wallet server 108. If a match is found, then the directory service 114 extracts the corresponding primary device and digital wallet application information data for the matching stored wallet profile, and transmits the starter to logic module 110.

At step 606, payment notification data is generated by the logic module 110. In the described appointments, payment notification data is generated by processing the primary device data to determine at least one of the type, structure and format of the notification for the request for payment information. That is, the payment notification data produced is specific to the digital wallet of the user 101 based on the received wallet identifier and the mapping of this identifier to information provided about the primary device 102 and digital wallet application 103 of the user 101 during the registration process. The digital wallet payment notification is transmitted to the primary device 102 via the communications network 106 using a secure transmission protocol (as discussed above).

In the described embodiments, the payment notification data is received by the primary device 102, and is processed to produce a payment notification which notifies the user 101 of the request for payment information from the merchant application 119 (as described below). The notification is rendered graphically on the GUI of the primary device 102, and includes purchase details such as an indication of the purchase amount and a description of the purchase; an identifier and/or name describing the merchant; and the time and date at which the purchase was initiated.

Performing the Digital Wallet Payment

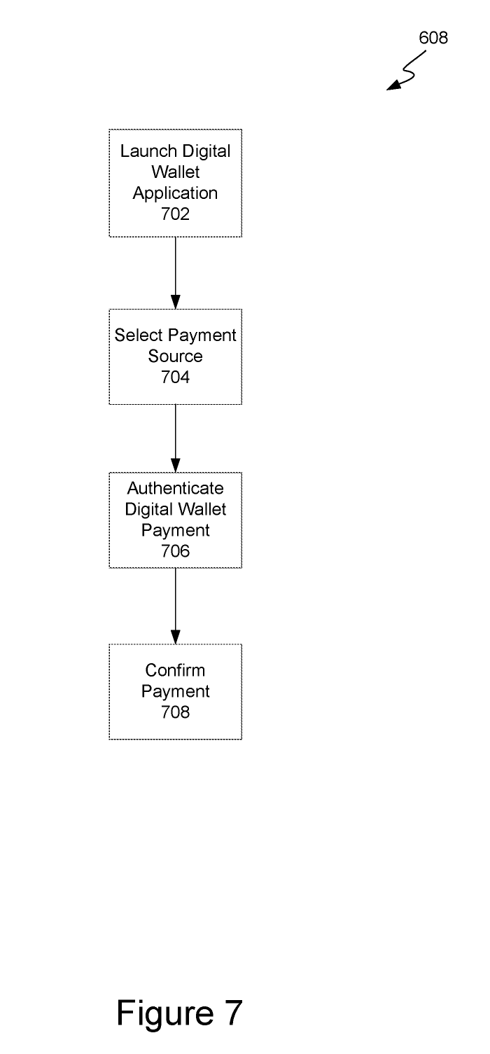

FIG. 7 illustrates the process of completing of a digital wallet payment from the primary device 102 on receiving the payment notification. At step 702, the digital wallet application 103 is executed, or made active if already executing, on the primary device 102. In some embodiments, the payment notification contains an active element configured to request the execution of the digital wallet application 103 by the operating system of the primary device 102 for the purpose of performing the payment. Alternatively, the user 101 can manually execute the digital wallet application 103 and can input the relevant transaction details into the application 103 in order to perform the digital wallet payment.

At step 704, the user 101 selects a payment source from the candidate payment sources associated with the digital wallet (i.e. payment sources added to the digital wallet application 103, as described above), and enters corresponding authentication information to authenticate the digital wallet payment with this selected instrument, at step 706 (as described above). The digital wallet application 103 prompts the user 101 to confirm the digital wallet payment by the display of a GUI element, such as a dialogue box, at step 708. If the user 101 confirms the payment, then the digital wallet application 103 generates payment information representing the selected payment source, and transmits this information to the wallet server 108.

In other embodiments, the cross device digital wallet payment system 100 can be configured to allow the user 101 to perform an “express payment” in place of the payment source selection and authentication steps 702 and 704. Specifically, in these embodiments the user 101 can designate a particular candidate payment source as a default instrument to use for express checkouts. The user 101 can perform a payment with this default instrument without entering any associated authentication credentials. When executing the digital wallet application 103, the user 101 can select to perform an express checkout and proceed directly to confirmation of the digital wallet payment, at step 708.

The payment information of the selected (or default) payment source is received by the communications module 116 of the wallet server 108 and is transmitted to the logic module 110 for processing, at step 610. The logic module 110 resolves the received payment information to the corresponding payment information request received by the merchant application 119. In some embodiments, the details of the payment information provided by the digital wallet application 103 are recorded by the directory service 114 of the wallet server 108 in a payment record structure such as for example a ‘payment record’ database table. The payment record structure records requests for cross device digital wallet payments associated with a particular wallet profile of a user registered with the system 100, and the corresponding payment information provided by this user's digital wallet in response to the request. For example, the information recorded in each payment record structure entry may include: a wallet identifier; the payment notification details that were transmitted to the digital wallet specified by the wallet identifier; and the payment information provided by the digital wallet to complete the payment.

The wallet server 108 can be configured to record the times when a cross device digital wallet payment request is received, when the payment notification is transmitted to the associated digital wallet, and when the corresponding payment information is received from that digital wallet. Completion of the cross device digital wallet payment can be configured to timeout if the wallet server 108 does not receive a response from the digital wallet within a predetermined period of time (such as, for example, two minutes). In this case, the completion of the digital wallet payment is considered as unsuccessful by the wallet server 108, and the logic module 110 generates payment failure data which is transmitted to the merchant application 119 requesting the payment information in respect of a transaction by the user 101. The merchant application 119 can be configured to process the payment failure data to generate a payment failure message which is displayed to the user 101 via GUI elements on the secondary device 104.

In some embodiments, the logic module 110 (at step 610) verifies the payment source specified by the payment information received from the digital wallet, based on the stored details of the payment sources associated with that digital wallet. For example, in the case of a digital wallet payment using a credit card instrument, the logic module 110 may extract the credit card number, the expiry date, and the OW code field data from the received payment information and instruct the directory service 114 to search for matching fields over the stored credit card instruments associated with the digital wallet. If the payment source specified by the received payment information does not match to any stored payment source for the digital wallet, then the logic module 110 can be configured to generate payment failure data which is transmitted to the merchant application 119, and subsequently processed as described above.

Completing the Payment

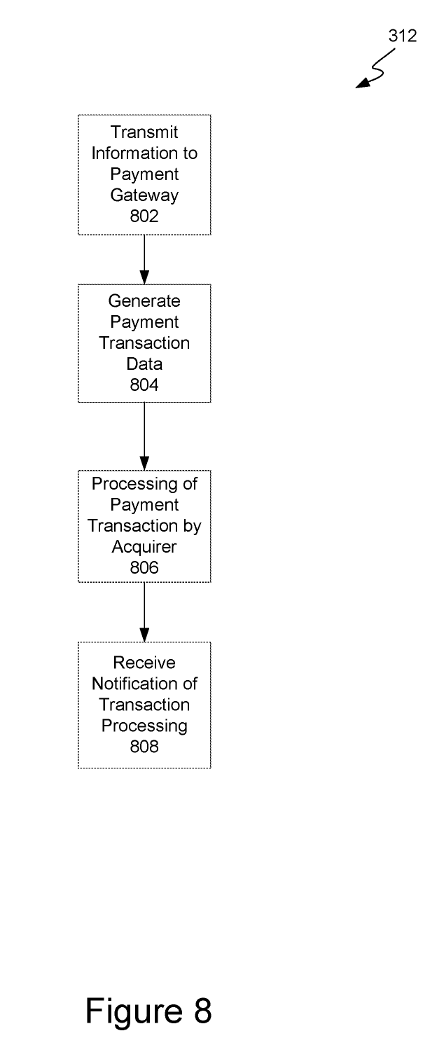

If the completion of the digital wallet payment is successful, then the wallet server 108 transmits the digital wallet payment information to the secondary device 104 (at step 310). At step 312, the digital wallet payment information is processed by the merchant application 119 to generate a financial payment transaction to complete the payment for the transaction initiated by the user 101 (as described above at step 502). As shown in FIG. 8, at step 802 the merchant application 119 transmits merchant details including merchant identification and acquirer information, the purchase information, and the received payment information to the payment gateway 130.

At step 804, the payment gateway 130 generates payment transaction data from the merchant identification and acquirer information, the purchase amount, and the payment source details of the payment information. The generated payment transaction conforms to the standard ISO 8583 financial transaction message protocol, with the message type identifier set to 0200 to indicate that the request is for a complete transaction (as opposed to an authorisation only).

The data field values of the payment transaction are set by the payment gateway 130 in accordance with the ISO 8583 standard. Specifically, data field 2 reflects the payment account corresponding to the payment source selected by the user 101.

Data fields 4-10 are set to represent the amount and currency of the payment (as determined by the purchase details), any associated conversion fees that are required, and the timing information of the transaction. The merchant ID information is used to set the data field values 18-21, representing the merchant type, the acquiring institution country code, the PAN value, and the forwarding institution country code respectively.

The transaction is then processed, at step 806, in accordance with standard procedures for processing a financial transaction involving an acquirer 132, a card association entity 134, and a corresponding issuer 136. At the conclusion of the transaction processing, a transaction notification is received by the merchant application 119 indicating the authorisation or denial of the payment for the transaction (at step 808). The cross device digital wallet payment system 100 is configured to display a notification of the successful completion of the transaction on the secondary device 104 used to initiate the transaction, and the primary device 102 used to perform the payment (at step 314). If the transaction notification indicates that the payment is authorised, the merchant application 119 is configured to display the success of the payment, and a corresponding digital receipt for the transaction, via GUI elements of the secondary device 104.

The merchant application 119 is configured to transmit the transaction notification to the wallet server 108 via an API call. The logic module 110 is configured to process the transaction notification including extracting primary device data for the corresponding digital wallet from the directory service 114. The logic module 110 generates digital wallet transaction notification data and transmits this data to the primary device 102 via the communications network 106. The digital wallet transaction notification data is processed by the primary device 102 to provide an indication of the success or failure of the digital wallet payment to the user 101. In the described embodiments, a corresponding digital receipt is displayed to the user 101 via GUI elements of the primary device 102. In some embodiments, the wallet server 108 is configured to store an indication of the success or failure of the digital wallet payment associated with a particular cross device digital wallet payment request in a payment record table (as described above), or similar data structure.

Many modifications will be apparent to those skilled in the art without departing from the scope of the present invention.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1. A process for performing a cross device digital wallet payment, including:
receiving payment request data from a secondary device, the payment request data representing a request for payment information to complete a transaction on a merchant application of the secondary device;
processing the received payment request data to determine:
i) primary device data, and digital wallet application data representing characteristics of a digital wallet application of the primary device; and
ii) payment notification data representing a notification of the request for payment information;
transmitting the payment notification data to the primary device;
receiving, from the primary device, payment information data to complete the transaction, said payment information data including an indication of a payment source associated with the digital wallet application; and
transmitting the payment information data to the secondary device.

2. The cross device digital wallet payment process of claim 1, wherein the payment request includes a wallet identifier uniquely identifying the combination of the digital wallet application and the primary device, the primary device being a smartphone, and the wallet identifier including the mobile phone number of the primary device.

3. The cross device digital wallet payment process of claim 2, wherein the processing of the received payment request data includes selecting primary device data and digital wallet application data, which correspond to the wallet identifier of the received payment request data.

4. The cross device digital wallet payment process of claim 3, wherein the primary device data and digital wallet application data which correspond to the wallet identifier, are determined from one or more wallet profiles of one or more respective users.

5. The cross device digital wallet payment process of claim 4, wherein the wallet profile of a user is generated by a process including the steps of:
receiving a registration request from the user, said request including:
user identification data representing the identity of the user; and
user wallet data representing a digital wallet application of the user and a primary device of the user on which the digital wallet application is executed; and
processing the user identification data and user wallet data to generate a wallet identifier of the user, said wallet identifier identifying the combination of the digital wallet application of the user and the primary device of the user among all other users having a wallet profile; and
associating the user wallet identifier with the combination of the user identification data and the user wallet data.

6. The cross device digital wallet payment process of claim 5, wherein the user identification data includes an indication of at least one of: the first name, last name, address, and mobile telephone number, of the user; and
the user wallet data includes, at least: a contact identifier of the primary device of the user; an indication of the device type of the primary device of the user; and an indication of the digital wallet application of the user.

7. The cross device digital wallet payment process of claim 5, wherein the generation of the payment notification data includes processing the primary device data to determine at least one of the type, structure and format of the notification for the request for payment information.

8. The cross device digital wallet payment process of claim 1, wherein the payment request data is received via a call to an Application Program Interface (API) function for the initiation of a cross device digital wallet payment, the call to the API function made by the merchant application, and wherein the merchant application is any one of: i) a mobile device application; and ii) a web browser rendering a website of the merchant.

9. The cross device digital wallet payment process of claim 1, wherein the merchant application includes: i) a purchasing interface configured to provide one or more options for a user of the merchant application to purchase goods and/or services from the merchant; and ii) a digital wallet plugin configured to initiate a cross device digital wallet payment for the transaction.

10. The cross device digital wallet payment process of claim 9, wherein the merchant application is executed by the secondary device, and where a user of the secondary device is the user of the merchant application.

11. A cross device digital wallet payment system, including at least one computing device being configured to perform a cross device digital wallet payment by carrying out the steps of:
receiving payment request data from a secondary device, the payment request data representing a request for payment information to complete a transaction from a merchant application of the secondary device;
processing the received payment request data to determine:
i) primary device data, and digital wallet application data representing a digital wallet application of the primary device; and
ii) payment notification data representing a notification of the request for payment information;
transmitting the payment notification data to the primary device;
receiving, from the primary device, payment information data to complete the transaction, said payment information data including an indication of a payment source associated with the digital wallet application; and
transmitting the payment information data to the secondary device.

12. A process for performing a cross device digital wallet payment, including:
receiving payment notification data representing a notification of a request for payment information to complete a transaction, said transaction initiated by a merchant application of a secondary device;
processing the payment notification data to generate payment source data representing a payment source to be used to complete the transaction, said payment source determined by a digital wallet application; and
processing the payment instrument data to generate payment information data representing the requested payment information.

13. The cross device digital wallet payment process of claim 12, wherein the payment notification data includes an indication of the digital wallet application, and wherein generating the payment source data includes generating authentication data authenticating the use of the payment source, the authentication data representing one or more of: a PIN code; and a biometric identifier.

14. The cross device digital wallet payment process of claim 12, wherein the payment notification data is received from a digital wallet server device, and the payment information data is transmitted to the digital wallet server device.

15. The cross device digital wallet payment process of claim 12, wherein the payment source is selected from a set of candidate payment instruments of the digital wallet application.

16. The cross device digital wallet payment process of claim 15, wherein the digital wallet application is configured to provide the user with the option to do any one or more of the following:
i) add a new payment source to the set of candidate payment instruments of the digital wallet application;
ii) remove a payment source from the set of candidate payment instruments of the digital wallet application; and
iii) modify the details of a candidate payment source of the digital wallet application.

17. A cross device digital wallet payment system, including at least one computing device being configured to perform a cross device digital wallet payment by carrying out the steps of:
receiving payment notification data representing a notification of a request for payment information to complete a transaction, said transaction initiated by a merchant application of a secondary device;
processing the payment notification data to generate payment source data representing a payment source to be used to complete the transaction, said payment source determined by a digital wallet application; and
processing the payment instrument data to generate payment information data representing the requested payment information.
